(19) United States
(12) Patent Application Publication
(10) Pub. No.: US 2014/0327815 A1
(43) Pub. Date: Nov. 6, 2014

(54) SMARTPHONE SCANNER ADAPTER

(71) Applicant: CVS Pharmacy, Inc., Woonsocket, RI (US)

(72) Inventor: Raymond W. Auger, North Scituate, RI (US)

(73) Assignee: CVS Pharmacy, Inc., Woonsocket, RI (US)

(21) Appl. No.: 13/887,857

(22) Filed: May 6, 2013

(51) Int. Cl. G03B 5/00

(52) U.S. Cl. CPC G03B 5/00
USPC 348/369

(57) ABSTRACT

A smartphone adapter for redirecting light to a camera mounted on a smartphone includes a housing, which includes (i) an aperture for receiving light reflected from a scannable symbol and (ii) a reflective surface for redirecting light received through the aperture to the smartphone camera, and a member for mechanically affixing the smartphone adapter to the smartphone.

### TECHNICAL FIELD

Embodiments of the present invention relate to electronic scanners and in particular to handheld, smartphone-based scanners.

### BACKGROUND

Feature-rich cellular telephones, or “smartphones,” are becoming increasingly powerful, versatile, and ubiquitous. Smartphones typically include such features as a powerful processor, a touchscreen, speakers and microphones, a camera, and cellular, Wi-Fi, and/or GPS antennas. These features allow smartphones to run many different kinds of software applications, and the functionality of many applications that previously required a separate, dedicated device, such as a GPS unit or MP3 player, may now be implemented as a software application running on a smartphone. Merchants may use dedicated universal product code (“UPC”) scanner devices, for example, to scan the UPCs on inventory items, shelf locations, customer ID cards, or in/on other places, but may instead wish to use a smartphone as a UPC scanner for reasons of economy or convenience. A smartphone user may position the smartphone's camera to capture an image of the UPC, and software running on the camera translates the UPC into a sequence of letters and/or numbers for further processing.

The camera lens of a smartphone is typically positioned on a side of the smartphone opposite the screen. This configuration is optimized for the most typical use case: allowing a user to take a photograph of a scene by holding the camera at approximately eye-level and viewing, on the screen, the image to be captured by the camera. UPCs may be placed on items closer to the ground, however, thus requiring a user to bend or stoop in order to capture the UPC with the camera. This requirement is exacerbated by many UPC-reading applications, which require that the camera captures an undistorted image of the UPC; the user must bend or stoop to position the camera parallel to the surface of the UPC and to view the screen of the smartphone to verify the position of the camera. A need therefore exists for an easier-to-use smartphone UPC scanner.

### SUMMARY

In general, various aspects of the systems and methods described herein include a smartphone adapter for coupling to a smartphone. The adapter includes an aperture for receiving light reflected from a UPC (or other symbol or code). The received light strikes a reflective surface housed in the adapter and is thereby redirected (by approximately 90 degrees) to thereafter strike a lens of a camera mounted on the smartphone. A user may then cause the smartphone to capture an image with the camera that includes the UPC. In this way, the user may position the smartphone such that a long axis of the smartphone is perpendicular to the surface that includes the UPC, thereby allowing the user to capture the image more comfortably. In one aspect, a smartphone adapter redirects light to a lens within a smartphone. A housing includes an aperture for receiving light reflected from a symbol and a reflective surface for redirecting light received through the aperture to the lens. A member couples the smartphone adapter to the smartphone. The reflective surface may redirect the light at an angle of approximately 90 degrees. The symbol may include a UPC. The reflective surface may include glass or plastic. The member may include metal, plastic, or rubber.

In another aspect, a method for capturing an image comprising a symbol using a smartphone includes positioning the smartphone and a coupled adapter such that the long axis of the smartphone is approximately perpendicular to a surface comprising the symbol; light reflected from the symbol is redirected after striking a reflective surface housed in the adapter strikes a camera lens on the smartphone. The smartphone captures an image that includes the symbol (by, e.g., being operated). The image or information related to the symbol may be transmitted to a remote computer, and the symbol may include a UPC.

In another aspect, a system for reading a symbol includes a smartphone including a camera that includes a lens and a housing (that includes an aperture for receiving light reflected from a symbol and a reflective surface for redirecting light received through the aperture to the lens). The housing is coupled to the smartphone. A member may couple the smartphone adapter to the smartphone; the member may include metal, plastic, or rubber. The reflective surface may redirect the light at an angle of approximately 90 degrees. The reflective surface may include glass or plastic, and the symbol may include a UPC.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is an exploded view of a smartphone adapter in accordance with an embodiment of the present invention;

FIG. 2A is a side view, parallel to long axis of a smartphone, of a smartphone adapter in accordance with an embodiment of the present invention;

FIG. 2B is a side view, perpendicular to a long axis of a smartphone, of a smartphone adapter in accordance with an embodiment of the present invention;

FIGS. 3A and 3B illustrate the operation of a smartphone adapter in accordance with an embodiment of the present invention; and

FIG. 4 is a flowchart of a method for using a smartphone adapter in accordance with an embodiment of the present invention.

### DETAILED DESCRIPTION

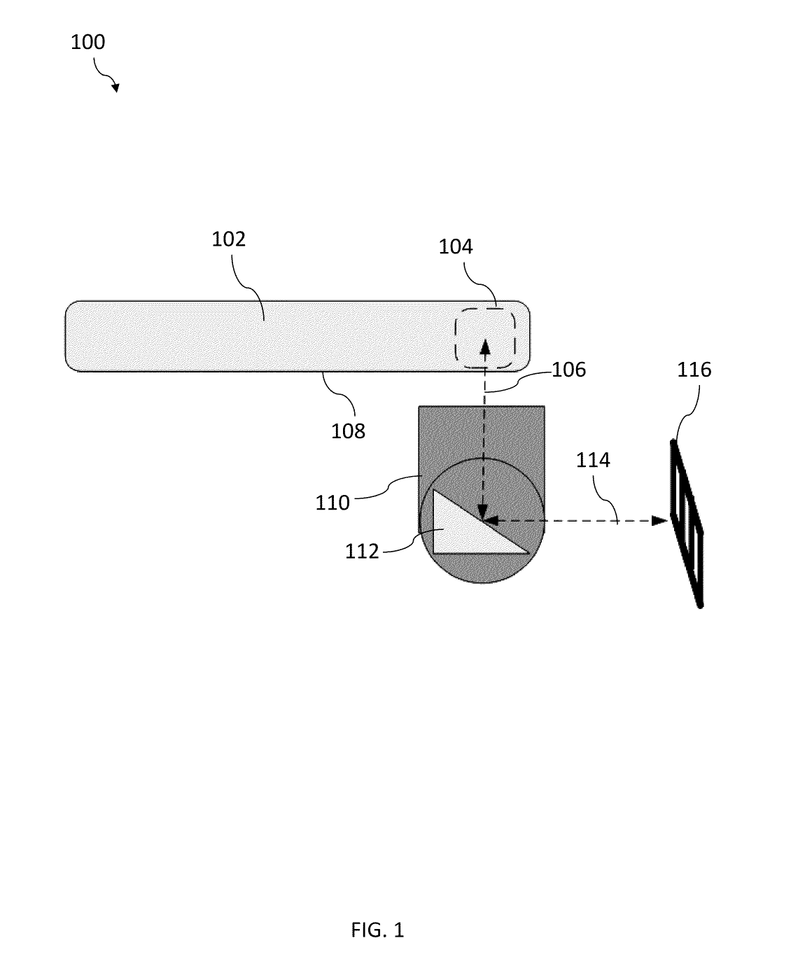

In one embodiment of the present invention, an adapter is mechanically coupled to a smartphone and changes a view captured by a camera incorporated into the smartphone to thereby facilitate the scanning of UPCs (or other similar codes or symbols) by the smartphone. FIG. 1 is a side view 100 of a scanner adapter parallel to a long axis of a smartphone 102. The smartphone 102 may be an APPLE IPHONE, an ANDROID phone (e.g., a SAMSUNG GALAXY, MOTOROLA DROID, or HTC DESIRE), a BLACKBERRY phone, a WINDOWS phone, or any other kind of smartphone. As used herein, the term “smartphone” includes other hand-held digital devices (e.g., a personal-digital assistant device that does not include telephone capabilities). The smartphone 102 includes a digital camera 104 (i.e., a focusing lens mounted on a face 108 of the smartphone 102 that focuses light incident thereon onto a charged-coupled device or other light sensor) and related software. The camera 104 receives light from a first direction 106, which is roughly perpendicular to a surface 108 upon which the camera 104 is mounted.

An adapter 110 may be coupled to the surface 108 of the smartphone 102 (as shown in greater detail below—to better explain the operation of the present invention, the adapter 110 of FIG. 1 is shown detached from the smartphone 102) over the camera 104 by any acceptable means. The adapter 110 contains a reflective surface 112 that redirects incoming light 114 to the camera 104. In one embodiment, the adapter 110 allows the user of the smartphone 102 to capture an image of a UPC 116 (or similar symbol, such as a QR code). The angle between the light 114 reflected from the UPC 116 and the light 106 redirected to the camera 104 may be approximately 90 degrees.

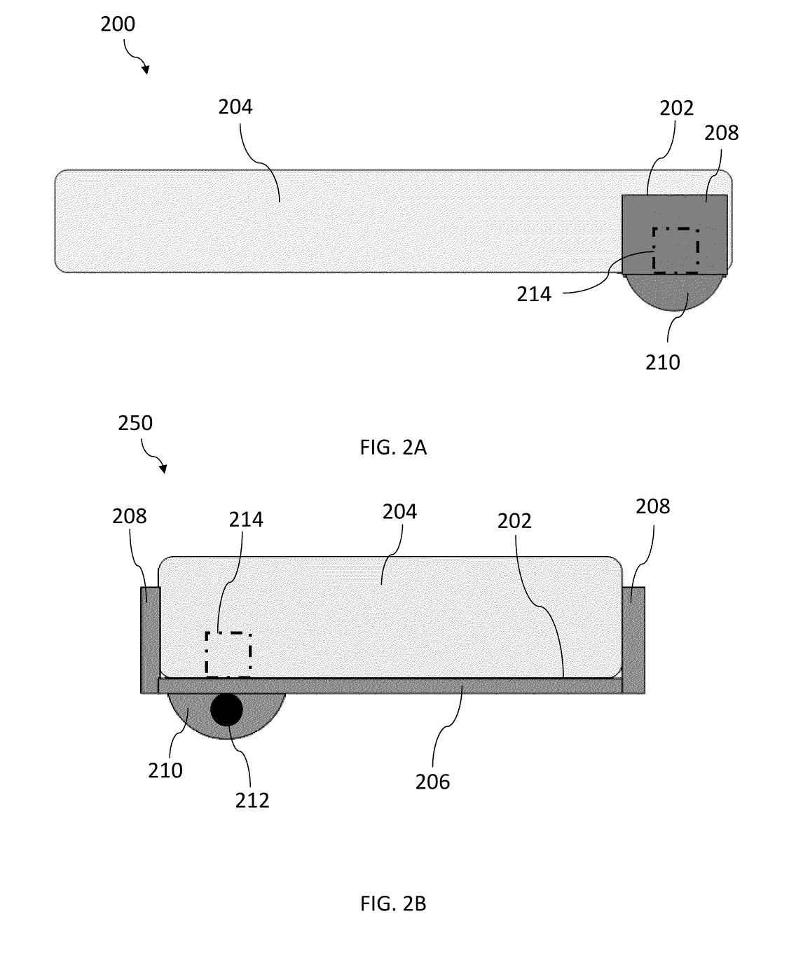

FIGS. 2A and 2B illustrate side views 200, 250 of an embodiment of an adapter 202 coupled to a smartphone 204; the first view 200 is parallel to a long axis of the smartphone 204 and the second view 250 is perpendicular to the long axis of the smartphone 204. As used herein, an adapter of the present invention is said to be “coupled” to a smartphone in that it is mechanically affixed, attached, clipped, or otherwise held against the smartphone by an suitable means in either a temporary or permanent basis. The adapter 202 includes a bottom member 206 running the width of the smartphone 204 and in contact thereto and side members 208 in contact with sides of the smartphone 204. A housing 210 is affixed to the bottom member 206 in a position proximate to a camera 214 incorporated into the smartphone 204. The housing 210 further includes an aperture 212; light enters the aperture 212 and is reflected from a reflective surface mounted within the housing 210 and is thereby re-directed to the camera 214 in the smartphone 204. The aperture 212 within the housing 210 is any suitable size, shape, and orientation so long as it is capable of receiving light reflected from a scannable symbol so that the light can be processed. In this embodiment, side members 208 are used to couple the adapter 202 to the smartphone 204 by, for example, applying mechanical pressure to the sides of the smartphone 204 (i.e., the side members “squeeze” the sides of the smartphone) and/or by mating with one or more features on the sides of the smartphone 204 (i.e., protrusions on the side members 208 that mechanically mate with indentations on the smartphone 204).

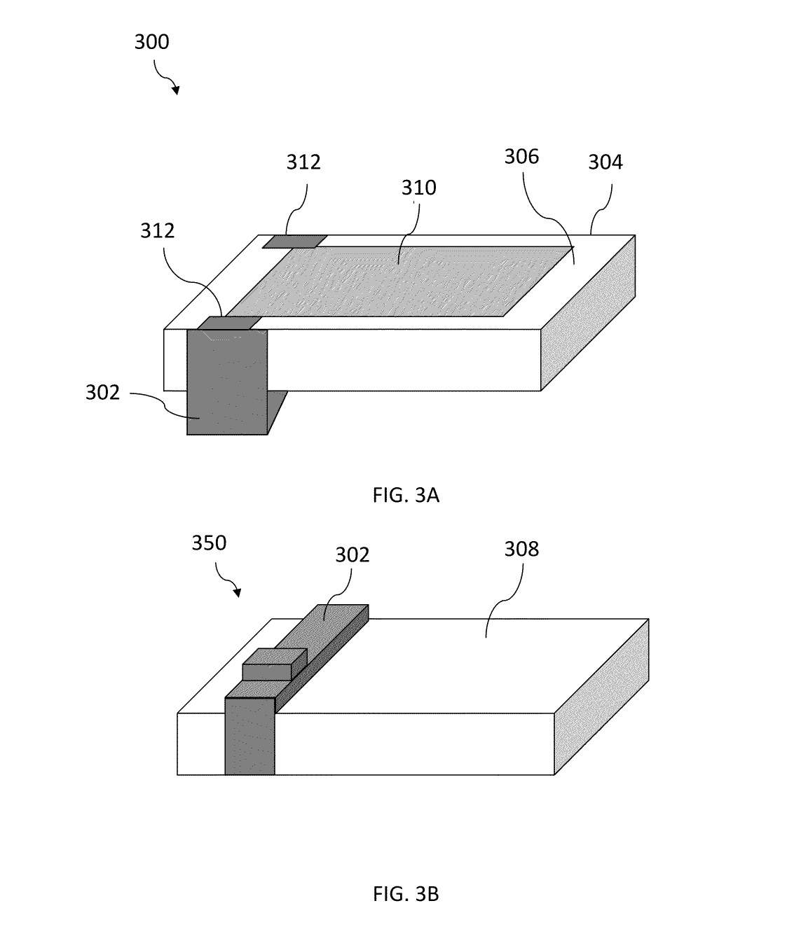

FIGS. 3A and 3B illustrate three-dimensional views 300, 350 of an adapter 302 coupled to a smartphone 304; the first view 300 shows a top face 306 of the smartphone 304 (including a screen 310) and the second view 350 shows a bottom face 308 of the smartphone 304. In this embodiment, top members 312 of the adapter 302 extend over a portion of the top face 306 of the smartphone 304 to provide mechanical support for affixing the adapter 302 to the smartphone 304.

FIGS. 2, 3A, and 3B illustrate exemplary embodiments of an adapter 202, 302, but the present invention is not limited to only these embodiments, and any system or method for affixing a housing having a reflective surface over the camera of a smartphone to thereby alter the angle of light incident upon the smartphone's camera are within the scope of the present invention. For example, the adapter may cover the entire back face and sides of the smartphone (similar to, e.g., a protective smartphone cover). The adapter may include more than one separable component; one component may include the housing and reflective surface, for example, while one or more additional components may be affixed to the first to allow the fixing of the plurality of components with different makes or models of smartphones.

The adapter may consist or comprise a variety of different materials. In one embodiment, the adapter is rigid or semi-rigid and is made using metal and/or plastic materials. The adapter may further include or consist wholly of elastomeric or otherwise flexible components, such as rubber or the like. In one embodiment, a portion of the adapter is rigid or semi-rigid and includes a flexible component (i.e., a rubber-band like component) across the front face of the smartphone for securing the adapter thereto.

The reflective surface may be metal, plastic, glass, or any combination thereof, and may reflect the light using reflection or other means (e.g., total internal refraction). In one embodiment, the adapter further includes a lens for focusing light incident upon the reflective surface and/or a lens for focusing light reflected from the reflective surface to the camera. For example, a wide-angle or magnifying lens may be used.

Any software running on the smartphone capable of capturing an image is within the scope of the present invention. The software may transmit the image to another computer, system, or application for processing and interpretation of the image (i.e., analyzing a UPC in the image to determine the numbers, letters, and/or symbols to which the UPC corresponds) or such processing may be performed on the smartphone itself. The capturing and analyzing of the image may be performed by the same or different applications. The smartphone may further include software for further processing of the data in the UPC, such as inventory control or management. The smartphone may include a Wi-Fi, cellular, BLUETOOTH, or other network link for the transmission of the image or image data. The smartphone may further receive data or instructions related to the scanning of UPCs from other computers or systems, such as instructions prompting a user as to which UPCs should be scanned.

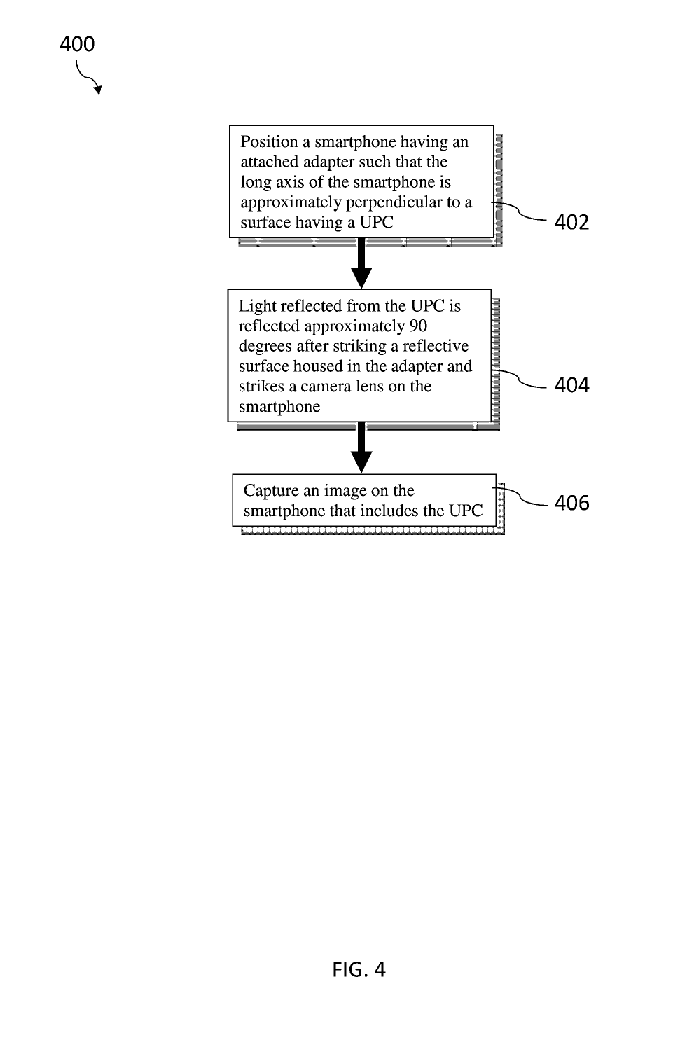

In one embodiment, a smartphone user captures a UPC (or other symbol) with a smartphone in accordance with the method 400 illustrated in FIG. 4. In a first step 402, the user positions a smartphone having an attached adapter such that the long axis of the smartphone is approximately perpendicular to a surface having a UPC. In a second step 404, light reflected from the UPC is reflected approximately 90 degrees after striking a reflective surface housed in the adapter and strikes a camera lens on the smartphone. In a third step 406, software on the smartphone captures an image that includes the UPC.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A smartphone adapter for redirecting light to a lens within a smartphone, the smartphone adapter comprising:
a housing comprising:
i. an aperture for receiving light reflected from a symbol; and
ii. a reflective surface for redirecting light received through the aperture to the lens;
a member for coupling the smartphone adapter to the smartphone.

2. The smartphone adapter of claim 1, wherein the reflective surface redirects the light at an angle of approximately 90 degrees.

3. The smartphone adapter of claim 1, wherein the symbol comprises a UPC.

4. The smartphone adapter of claim 1, wherein the reflective surface comprises glass or plastic.

5. The smartphone adapter of claim 1, wherein the member comprises metal, plastic, or rubber.

6. A method for capturing an image comprising a symbol using a smartphone, the method comprising:
positioning a smartphone having a coupled adapter such that the long axis of the smartphone is approximately perpendicular to a surface comprising the symbol, wherein light reflected from the symbol is redirected after striking a reflective surface housed in the adapter to thereby strike a camera lens on the smartphone; and
capturing an image on the smartphone that includes the symbol.

7. The method of claim 6, further comprising operating the smartphone to capture the image.

8. The method of claim 6, further comprising transmitting the image or information related to the symbol to a remote computer.

9. The method of claim 6, wherein the symbol comprises a UPC.

10. A system for reading a symbol, the system comprising:
a smartphone comprising a camera comprising a lens; and
a housing comprising:
i. an aperture for receiving light reflected from a symbol; and
ii. a reflective surface for redirecting light received through the aperture to the lens,
wherein the housing is coupled to the smartphone.

11. The system of claim 10, further comprising a member for coupling the smartphone adapter to the smartphone.

12. The system of claim 11, wherein the member comprises metal, plastic, or rubber.

13. The system of claim 10, wherein the reflective surface redirects the light at an angle of approximately 90 degrees.

14. The system of claim 10, wherein the symbol comprises a UPC.

15. The system of claim 10, wherein the reflective surface comprises glass or plastic.
